(19) United States
(12) Patent Application Publication
(10) Pub. No.: US 2026/0223141 A1
(43) Pub. Date: Jul. 30, 2026

(54) COORDINATING CHANNEL ACCESS FOR MULTI-LINK DEVICES

(71) Applicant: Telefonaktiebolaget LM Ericsson (publ), Stockholm (SE)

(72) Inventors: Rocco DI TARANTO, Lund (SE); Abhishek AMBEDE, Huddinge (SE); Charlie PETTERSON, Solna (SE); Sebastian MAX, Cologne (DE); Leif WILHELMSSON, Lund (SE); Guido Roland HIERTZ, Aachen (DE)

(73) Assignee: Telefonaktiebolaget LM Ericsson (publ), Stockholm (SE)

(21) Appl. No.: 19/148,636

(22) PCT Filed: Jan. 18, 2023
(86) PCT No.: PCT/EP2023/051144

§ 371 Date: Jul. 16, 2025

(51) Int. Cl. H04W 72/27; H04W 76/15

(52) U.S. Cl. CPC H04W 72/27; H04W 76/15

(57) ABSTRACT

A method performed by a first access point, AP,-multi-link device, MLD, AP-MLD, in a wireless network. The method comprising using a first channel, transmitting towards a second AP-MLD a first message that includes information about one or more actions associated with a second channel. The method further comprises receiving, from the second AP-MLD using the first channel, a second message related to the first message. Wherein the first and second channels are different, the first AP-MLD and the second AP-MLD are in range using the first channel, and the first AP-MLD and the second AP-MLD are not in range using the second channel.

### TECHNICAL FIELD

This disclosure relates to coordinating channel access for multi-link devices.

### BACKGROUND

Channel planning is essential in license-exempt frequency bands to avoid or at least limit interference, especially in dense access point (AP) deployments. With more and more license-exempt channels being available in multiple frequency bands (e.g., 2.4 GHz, 5 GHz, 6 GHZ, and 60 GHz) and with different channel bandwidths available, it is not clear how different APs in proximity with each other should select their operating bandwidths.

On one hand, all APs could attempt to always use the maximum bandwidth available on each operating channel. The number of operating channels will depend on the devices'capabilities. This may correspond to usage of 160 MHz in IEEE 802.11ax and 320 MHz in IEEE 802.11be, and possibly even larger bandwidths, for example 640 MHz wide channels may be available in the coming years. When the density of APs is low, this could be a viable option, with few or no collisions, and very short transmissions in time.

On the other hand, the most common approach today when configuring wireless local-area networks (WLANs) with high density AP deployment is to allocate a narrow bandwidth channel to each AP and to reduce its transmit power, which results in a large distance between two APs using the same channel. In enterprise Wi-Fi networks, the default practice is to use narrow 20 MHz channels. See High Density Wi-Fi Deployments Guide, Cisco Meraki (Nov. 22, 2022), https://documentation.meraki.com/Architectures_and_Best Practices/Cisco_Meraki_Best_Practice_Design/Best_Practice_Design_-_MR_Wireless/High_Density_Wi-Fi_Deployments; Channel Planning Best Practices for Better Wi-Fi, Ekahau (Apr. 1, 2022), https://www.ekahau.com/blog/channel-planning-best-practices-for-better-wi-fi/. This may be a viable solution when many APs coexist and the number of (available and non-crowded) channels is limited, as Wi-Fi networks are known to perform very poorly in case of high co-channel interference, which would be the case in these conditions.

As for the channel access mechanisms, besides plain Enhanced Distributed Channel Access (EDCA), various flavors have lately been introduced in the Institute of Electrical and Electronics Engineers (IEEE) 802.11 standard to enable better coexistence on the same channel. For example, the IEEE 802.11ax amendment, Subclause 21.10 defines “spatial reuse” (also known as “coloring”) and “PSR-based” spatial reuse mechanisms. The main objective of these mechanisms is to maximize the utilization of the spectrum by increasing the number of concurrent transmissions on the same frequency channel, i.e., allowing for better reuse of the spectrum.

Yet another standardized solution to enable better coexistence of APs is channel puncturing (introduced in IEEE 802.11ax and further extended in IEEE 802.11be), which allows an AP to transmit on wide channels that are punctured on busy/occupied subchannels.

Furthermore, by complying with local regulations and therefore applying transmit spectral power masks (see e.g., ETSI 303 687 in Europe) AP coexistence can be to some extent favored.

IEEE 802.11be, Extremely High Throughput (EHT), Wi-Fi 7 The IEEE 802.11 Task Group “be” (TGbe) is currently developing the next major amendment to the IEEE 802.11-2020 WLAN standard, denoted as IEEE 802.11be (also termed as Extremely High Throughput ‘EHT’), which will be certified by the Wi-Fi Alliance as Wi-Fi 7. See IEEE P 802.11be/D2.3, November 2022. Its main features include but are not limited to multi-link (ML) operation, multi-RU (resource unit) allocation, up to 320 MHz channel bandwidths, and 4096-QAM modulation. A feature for latency reduction, namely Restricted Target Wake Time (r-TWT) is also introduced.

### Multi-Link (ML) Operation in EHT

ML is a key new feature introduced in EHT. See IEEE P802.11be/D2.3, November 2022. In ML, a device termed as a multi-link device (MLD) has multiple affiliated stations (STAs), each of which can communicate using independent wireless channels (links).

Communication over multiple links by an MLD is termed as multi-link operation (MLO). For example, an MLD can have two affiliated STAs-one communicating using a channel in the 5 GHz frequency band and the other communicating using a channel in the 6 GHz frequency band. Alternatively, as another example, an MLD can have two affiliated STAs-each communicating using channels in the 6 GHz frequency band. An AP MLD means an MLD with two or more affiliated AP STAs, whereas a non-AP MLD means an MLD with two or more affiliated non-AP STAs.

### TWT and Restricted-TWT

In the IEEE 802.11ax amendment, one of the introduced features is Target Wake Time (TWT), which allows an AP to negotiate a schedule with one or more of its associated non-AP STAs for waking up at specific time intervals for frame exchanges and thus in certain scenarios, schedule activity in its basic service set (BSS). Initially, TWT was designed and introduced only to reduce the required amount of time that a non-AP STA utilizing a power management mode needs to be awake. However, a TWT agreement also allows non-AP STAs to allocate and operate at non-overlapping times, and therefore bundles the frame exchanges in predefined service periods (SP). If managed properly, this feature can help with conducting operations similar to a scheduled system (e.g., in an interference free controlled environment).

Furthermore, the bundling may also enable an AP to reduce contention between non-AP STAs, as the number of simultaneous active non-AP STAs could be lowered by separating them into different SPs of different TWT agreements.

EHT introduces restricted TWT (r-TWT) which builds upon the same principle as TWT of scheduling SPs for STAs, however with increased protection of the r-TWT SPs wherein only specific selected STAs are allowed to participate to undertake their e.g., latency critical data communications. See IEEE P 802.11be/D2.3, November 2022. It also allows an AP to prioritize certain latency sensitive traffic flows (although this mechanism is currently TBD in the draft amendment).

To protect an r-TWT SP from other devices trying to access the medium an r-TWT SP scheduling AP may signal a quiet interval with the same start time as the r-TWT SP with a duration of 1 time unit (1 TU=1024 μs). Additionally, r-TWT capable non-AP STAs shall ensure that their ongoing transmit opportunity (TXOP) ends before any upcoming r-TWT SP advertised by the associated AP. Similarly, if they are not a member of an upcoming r-TWT SP, they cannot start new data transmissions that will not finish before the r-TWT SP starts as well.

### Multi-AP Coordination

In TGbe, multiple access point (MAP) coordination was one of the candidate features for the amendment. However, over the lifetime of the task group (TG) the feature was down prioritized and eventually dropped. MAP coordination assumes that system performance can be improved if the APs within an area coordinate to facilitate each other's operations instead of working independently. Following are examples of techniques that may be used for MAP coordination:
coordinated spatial reuse (CSR), which coordinates transmit power between different devices such that proper spatial reuse may be achieved;
coordinated beamforming (CBF), where each device places nulls in certain direction to reduce or eliminate interference at the intended receivers;
coordinated OFDMA/TDMA (C-OFDMA/C-TDMA), where frequency or time resources are orthogonally split up rather than reused among coordinating APs;
coordinated joint transmissions (JT), which allows multiple coordinating APs to jointly transmit to the same non-AP STA(s) to increase throughput;
cooperative OFDMA, where multiple coordinating APs transmit to the same non-AP STA(s) but on different RUs which may be appealing for reliability purposes;

synchronized downlink (DL)/ uplink (UL) direction, this may be attractive as its easier to predict downlink interference rather than uplink interference due to the mobility of non-AP STA(s);

coordinated-TWT, which would allow an AP to share information related to its r-TWT SP schedule with a nearby AP, so that the other AP may perform a specific action during the SPs of that r-TWT schedule-for example, stay quiet or lower the transmit power in order to reduce interference; and
coordinated handover, where multiple APs may coordinate to execute smoother/faster handovers of one or more of their non-AP STAs from one AP to another.

### Latest Relevant Contributions and Developments from UHR SG

In July 2022, the IEEE 802.11 Working Group (WG) agreed to start the study group Ultra High Reliability (UHR SG) to initiate the development of the next generation major amendment of the IEEE 802.11 WLAN standard. See July 2022 Working Group Motions, https://mentor.ieee.org/802.11/dcn/22/11-22-0872-05-0000-july-2022-working-group-motions.pptx. It was agreed that UHR SG will investigate technology which may improve reliability of WLAN connectivity, reduce latencies, along with other improvements.

In UHR SG, MAP coordination is again being actively discussed as a potential candidate feature. See Multi AP coordination for next-generation Wi-Fi, IEEE 802.11-22/1530r1; Multi-AP Coordination for Low Latency Traffic Delivery, IEEE 802.11-22/1556r1; Multi-AP Coordination for UHR, IEEE 11-22-1512-00-0uhr; A candidate feature: Multi-AP, IEEE 802.11-22/1515r0; Considerations on Multi-AP Coordination, IEEE 802.11-22/1516r0. During the UHR SG telephone calls held in late September 2022, a couple of related contributions were presented.

A first contribution, together with a similar previous contribution from TGbe (Multi-AP: TWT Information Sharing, IEEE 802.11-21/1046r3), illustrates how coordination among APs can benefit Wi-Fi operation, especially when done in the time domain. See Multi AP coordination for next-generation Wi-Fi, IEEE 802.11-22/1530r1. The idea in the first contribution is that neighboring APs can share TWT information of their respective BSS to reduce overlapping BSS (OBSS) interference experienced by the STAs. For example, to facilitate its r-TWT operation, an AP may request a neighbor AP to quiet the operations in the neighbor AP's BSS. The first contribution, however, does not discuss ML capabilities when the APs are AP-MLDs.

Other contributions similarly discuss potential MAP coordination solutions and related advantages that may be leveraged in the UHR SG. See Multi-AP Coordination for UHR, IEEE 11-22-1512-00-0uhr; A candidate feature: Multi-AP, IEEE 802.11-22/1515r0; Considerations on Multi-AP Coordination, IEEE 802.11-22/1516r0.

While the latest UHR SG contributions discuss MAP coordination, they do not discuss solutions for leveraging ML capabilities when the coordinating access points are AP MLDs.

### SUMMARY

Certain challenges exist. For example, there may be a scenario where multiple AP MLDs (e.g., a first AP MLD and a second AP MLD) are in range in certain bands (e.g., 6 GHZ) but are not in range in other bands (e.g., 60 GHz). In such scenario, if a non-AP STA is served by the 60 GHz band provided by the first AP MLD while it is also in the 60 GHz band service area of the second AP MLD, the non-AP STA may suffer interference caused by the signals travelling in the 60 GHz band service area of the second AP MLD when the non-AP STA communicates with the first AP MLD. In order to prevent such interference, there is a need for the first AP MLD and the second AP MLD to coordinate usage of the 60 GHz band such that the interference in the 60 GHz is prevented or reduced. But the existing art does not provide a way of allowing multiple AP MLDs to coordinate usage of channels in a particular frequency band where they are not in range. In another scenario, the first AP MLD and the second AP MLD are in range in both 6 GHz and 60 GHz bands, but the second AP MLD does not transmit or receive signals in the 60 GHz band while the first AP MLD transmits or receives signals in the 60 GHZ band. In this scenario, if the second AP MLD begins to transmit and/or receive signals in the 60 GHz band, there may be an interference in the 60 GHz band. Thus, it is desirable for the first AP MLD and the second AP MLD to coordinate the usage of channels in the 60 GHz band in order to prevent such interference.

Accordingly, in one aspect of the embodiments of this disclosure, there is provided a method performed by a first access point, AP,-multi-link device, MLD, AP-MLD, in a wireless network. The method comprises using a first channel, transmitting towards a second AP-MLD a first message that includes information about one or more actions associated with a second channel. The method further comprises receiving, from the second AP-MLD using the first channel, a second message related to the first message. The first and second channels are different. The first AP-MLD and the second AP-MLD are in range using the first channel. The first AP-MLD and the second AP-MLD are not in range using the second channel.

In another aspect, there is provided a method performed by a first access point, AP,-multi-link device, MLD, AP-MLD, in a wireless network. The method comprises using a first channel, transmitting towards a second AP-MLD a first message that includes information about one or more actions associated with a second channel. The method further comprises receiving, from the second AP-MLD using the first channel, a second message related to the first message. The first and second channels are different. The first message is a multiple access point (MAP) coordination message or a restricted target wake time (r-TWT) message.

In another aspect, there is provided a first access point, AP,-multi-link device, MLD, AP-MLD, the first AP-MLD. The first AP-MLD comprises a memory; and a processing circuitry coupled to the memory. The processing circuity is configured to cause the first AP-MLD to: using a first channel, transmit towards a second AP-MLD a first message that includes information about one or more actions associated with a second channel; and receive, from the second AP-MLD using the first channel, a second message related to the first message, wherein the first and second channels are different, the first AP-MLD and the second AP-MLD are in range using the first channel, and the first AP-MLD and the second AP-MLD are not in range using the second channel.

In another aspect, there is provided a first access point, AP, -multi-link device, MLD, AP-MLD, the first AP-MLD. The first AP-MLD comprises a memory; and a processing circuitry coupled to the memory. The processing circuity is configured to cause the first AP-MLD to: using a first channel, transmitting towards a second AP-MLD a first message that includes information about one or more actions associated with a second channel; and receiving, from the second AP-MLD using the first channel, a second message related to the first message, wherein the first and second channels are different, and the first message is a multiple access point (MAP) coordination message or a restricted target wake time (r-TWT) message.

In another aspect, there is provided a computer program comprising instructions which when executed by processing circuitry cause the processing circuitry to perform the method of any one of the embodiments described above.

In another aspect, there is provided a carrier containing the computer program of any one of the embodiments described above, wherein the carrier is one of an electronic signal, an optical signal, a radio signal, and a computer readable storage medium.

Embodiments of this disclosure allow multiple AP MLDs to coordinate usage of channels in frequency band(s) such that potential signal interference in the frequency band(s) can be prevented or reduced.

### BRIEF DESCRIPTION OF THE DRAWINGS

The accompanying drawings, which are incorporated herein and form part of the specification, illustrate various embodiments.

FIG. 1 shows a portion of a wireless network system according to some embodiments.

FIGS. 2A and 2B illustrate establishing an agreement between two AP-MLDs using beacon signals according to some embodiments.

FIG. 3 shows a frame for establishing an agreement between AP-MLDs according to some embodiments.

FIG. 4 illustrates an agreement between two AP-MLDs according to some embodiments.

FIG. 5 shows a portion of a wireless network system where AP-MLDs are out of range for at least one frequency band according to some embodiments.

FIG. 6 shows a portion of a wireless network system where a new AP-MLD is detected according to some embodiments.

FIG. 7 illustrates dense AP-MLD deployment according to some embodiments.

FIG. 8A illustrates sharing a r-TWT SP schedule corresponding to a first channel to another nearby AP MLD using a second channel according to some embodiments.

FIG. 8B illustrates setting up a MAP coordination corresponding to a first channel to another nearby AP MLD using a second channel according to some embodiments.

FIG. 9A shows a process according to some embodiments.

FIG. 9B shows a process according to some embodiments.

FIG. 10 shows an apparatus according to some embodiments.

### DETAILED DESCRIPTION

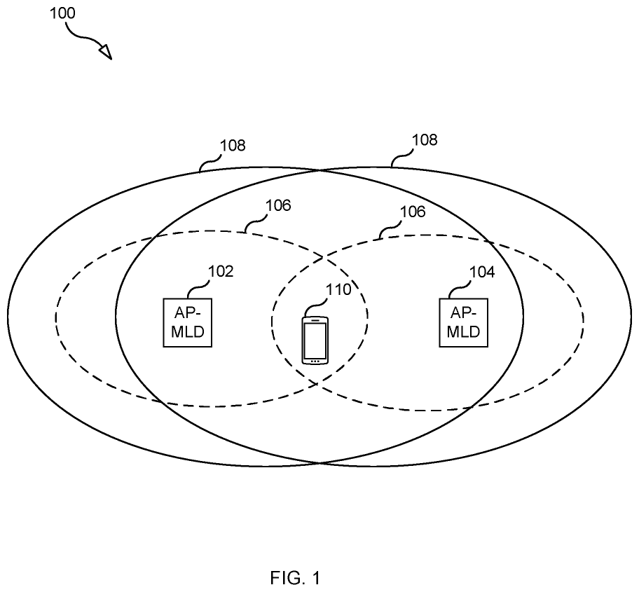

FIG. 1 shows a portion of a wireless network system 100 according to some embodiments. Wireless network system 100 comprises a first access point, AP, -multi-link device, MLD, (AP-MLD) 102, a second AP-MLD 104, and one non-AP device 110 associated with the first AP-MLD 102. The first AP-MLD 102 may communicate with the non-AP device 110 over one or more channels in a first frequency band. The second AP-MLD 104 may operate independently on said one or more channels in the first frequency band, thereby causing interference with the first AP-MLD 102's communications with the non-AP device 110. The one or more channels in the first frequency band have first coverage areas 106.

In order to reduce or prevent such interference, the first AP-MLD 102 and the second AP-MLD 104 need to coordinate usage of said one or more channels in the first frequency band. However, the first AP-MLD 102 and the second AP-MLD 104 cannot coordinate usage of said one or more channels in the first frequency band by exchanging signals via said one or more channels in the first frequency band because the first AP-MLD 102 and the second AP-MLD 104 are not in range using said one or more channels in the first frequency band, as seen by the first coverage areas 106 of FIG. 1.

Therefore, according to some embodiments, there is provided a method of coordinating (i.e., making an agreement) the usage of said one or more channels in the first frequency band using different channel(s) of the first frequency band or one or more channels of the second frequency band. The different channel(s) of the first frequency band or the one or more channels of the second frequency band have second coverage areas 108.

### 1. Global Agreement

As explained above, the interference can be prevented or reduced by making an agreement regarding the usage of said one or more channels in the first frequency band using different channel(s) of the first frequency band or one or more channels of the second frequency band. One type of such agreement is a global agreement.

The global agreement may define how the AP-MLDs will use all available license-exempt frequency bands which they can potentially use. The license-exempt frequency bands may refer to frequency bands which may be shared by any number of users complying with a set of standards and regulations. In other embodiments, the AP-MLDs may re-negotiate part of or the whole global agreement to accommodate needs that change over time.

In other embodiments, the global agreement may define one or more actions associated with the one or more AP-MLDs. The one or more actions may include tuning transmit parameters in one or more frequency bands; orthogonalizing communications in one or more frequency bands in time and/or frequency; adjusting preamble detection thresholds corresponding to one or more frequency bands; adjusting channel access parameters corresponding to one or more frequency bands; intermittently pausing transmissions on one or more frequency bands; terminating operations on one or more and moving the terminated operations to a different operating channel; selecting a transmission direction for one or more frequency bands; and/or adapting beamformed transmissions so as to keep emissions from interfering with beamformed transmissions of the second AP-MLD.

Once an agreement between the AP-MLDs regarding usage of one or more channels in certain frequency band(s) is formed, each AP-MLD may inform its associated non-AP devices on the resulting transmit parameters, for example on the AP's operating channel, channel bandwidth etc. In FIG. 1, the first AP-MLD 102 may transmit the transmit parameters towards its associated non-AP devices 110 in its service area 106 after establishing an agreement with the second AP-MLD 104. In some embodiments, the first AP-MLD 102 may use a beacon signal to inform the non-AP devices 110 that some transmission parameters are going to be changed in the corresponding basic service set (BSS).

### 1.1 Global Agreement Setup

In some embodiments, a global agreement may be established over the air between the AP-MLDs at the beginning of operations. For example, a global agreement may be established when a second AP-MLD turns on and is in range of another already operating AP-MLD, or for example when a third AP-MLD turns on and is in range of two already operating AP-MLDs. A new global agreement may also be settled when one or more AP-MLDs stop operating.

The AP-MLDs may agree beforehand on a set of available global agreements, where every agreement specifies how the license-exempt frequency band is divided across all available channels. There may be different set of agreements for different number of participating AP-MLDs. In some embodiments, the AP-MLDs may agree to have no agreement and continue to operate independently of each other. In other embodiments, other types of agreements may include: equal share between AP-MLDs, allocation based on needs, location specific agreements (fraction of bandwidth allocated to each AP-MLD depends on the AP-MLD's location, for example an AP-MLD in a hotel hall is allocated more than an AP-MLD in a hotel room), time-dependent agreements (for example during the day a certain agreement may hold, while a different agreement holds during the night), specific agreements to be used when neighbor's neighbors are not in range.

In case an agreement is not reached, or a renegotiation fails, the AP-MLDs may agree on a fallback agreement or operate without an agreement.

### 2. Establishing An Agreement

To settle an agreement over the air, the AP-MLDs may have at least one operating channel in common. The global agreement can be settled, for example when the AP-MLDs have the same primary channel, using beacon signals each AP-MLD transmits in the primary channel. A new field could be added to the beacon frames to support this additional feature of negotiation and setting up agreements. In other embodiments, a new frame itself could be defined to support this feature.

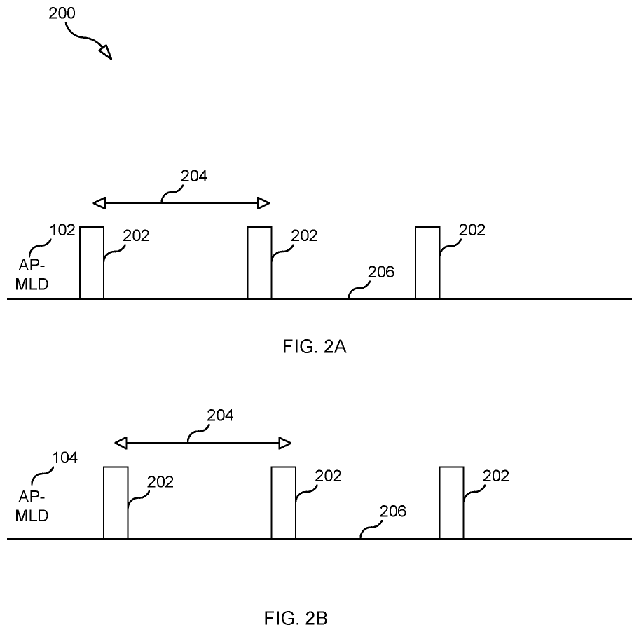

As referenced above, in establishing an agreement between themselves, the first AP-MLD 102 and the second AP-MLD 104 may use beacon signals over a common primary channel. FIGS. 2A and 2B show an exemplary illustration wherein the first AP-MLD 102 and the second AP-MLD 104 establish an agreement over a common primary channel using beacon and control frames. In this embodiment, the agreement between the first AP-MLD 102 and the second AP-MLD 104 can be setup using the beacons 202 over a common primary channel 206. The beacons 202 may be transmitted every period of time 204. In an alternative embodiment, the first AP-MLD 102 and the second AP-MLD 104 could be required to transmit their proposed agreements with control messages sent separately from beacons, e.g., once per second/minute on the other AP-MLD's primary channel.

The first 102 and the second 104 AP-MLD may establish an agreement, or re-negotiate an agreement, in a number of different embodiments. In a first embodiment, the AP-MLDs may share a common primary channel and use beacon signals to establish an agreement. The first embodiment is illustrated in FIGS. 2A and 2B. For example, all AP-MLDs can agree to use channel 1 in 6 GHz as a primary 20 MHz channel.

In a second embodiment, the first 102 and the second 104 AP-MLD may establish an agreement over a common channel, which is not a primary channel. In some embodiments, the common channel may be a 20 MHz subchannel. In such embodiments, they can use non-high throughput (non-HT) frame duplication so that they can cover this subchannel when communicating for setting up the agreements. The AP-MLDs may have previously agreed to use the common channel. For example, all AP-MLDs can agree to use channel 1 in 6 GHz as a common communication channel, and each of the AP-MLDs may choose their own primary 20 MHz channels.

In such embodiments, the AP-MLDs may select the common channel based on higher priority (e.g., video or voice) data is communicated less frequently over the common channel when compared to other channel(s), lesser amount of higher priority (e.g., video or voice) data is communicated over the common channel when compared to other channel(s), the common channel is less busy (e.g., due to lesser amount of data traffic communicated over it) when compared to other channel(s), the common channel is less noisy (e.g., due to fewer interfering transmissions) than other channel(s), the common channel occupies less bandwidth (e.g., control signaling is transmitted in a non-HT DUP format which means that it is more spectrally efficient to use narrower channels for this communication) than other channel(s).

In a third embodiment, the first 102 and the second 104 AP-MLD may not share any common static operating channels. In such embodiments, the AP-MLDs may dynamically assign the communication channel. The first 102 and/or the second 104 AP-MLD may scan the different operating channels to determine where the other AP-MLD operates. There are numerous channels available across 2.4 GHz, 5 GHZ, and 6 GHz frequency bands, for example, where the AP-MLDs may operate. In embodiments with dynamic communication channel assignment, the AP-MLDs may regularly scan frequency bands and address surrounding AP-MLDs on their main channel. Such main channel could be announced in beacon frames, e.g., indicating that an AP-MLD prefers to be contacted, “here” for negotiation purposes.

In the embodiments described above, one or more communication/signaling channels are used by all AP-MLDs in agreement. These channels may be used exclusively for this purpose (pre-defined control channel) or also for shared data transmission. Some features that could enable the usage of such pre-defined control channels include:
1) Multi-link as in 11be: In Multi-link (ML), a device has multiple affiliated stations (STAs), each of which can communicate using independent wireless channels (links). One of the channels may be used for this purpose.
2) Multi-band operation in legacy Wi-Fi: A multi-band AP is a device that can use several frequency bands to setup several independent Wi-Fi networks. One of the networks may be used for this purpose.
3) Enhanced Multilink Single-Radio (EMLSR)/Simultaneous Transmit and Receive, Enhanced Multi-link Multi-radio (EMLMR) multi-link solutions as in 11be: They allow a device to listen for some control or management messages on a channel that otherwise cannot be used for data reception.

In another embodiment, AP-MLDs could opportunistically use side spectrum, i.e., guard band, on certain agreed channels to communicate control data.

In the embodiments described above, the AP-MLDs may have agreed on a set of frames and/or fields to setup an agreement. An already existing common frame may, for example, be the beacon frame in FIGS. 2A and 2B sent regularly by the AP-MLDs to coordinate operations in their own BSSs.

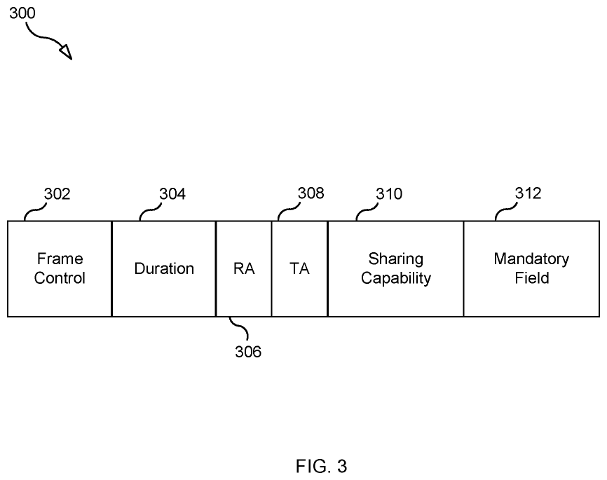

The beacons 202 or other dedicated/new frames may include specific fields when setting up an agreement between the AP-MLDs. In the first embodiment above, the beacon 202 may include one or more additional fields, an optional “Sharing Capability” field 310 and a mandatory “Proposed Sharing Agreement” field 312. The additional fields are described in more detail below. The second and third embodiments described above may require a new frame illustrated in FIG. 3 to establish an agreement.

FIG. 3 shows an example of a frame (300) according to some embodiments. The frame 300 includes a frame control field 302, a duration field 304, a receiving address field 306, and a transmitting address field 308.

When an AP-MLD intends to begin an agreement, the frame 300 may include one or more additional fields as part of a “BW sharing agreement request” frame. The optional “Sharing Capability” field 310 typically sent only at the beginning of the operations, when a new AP-MLD turns on, or when a completely new agreement needs to be setup. In some embodiments, the Sharing Capability field 310 may contain a bitmap indicating which agreements are supported by the sending AP-MLD. The mandatory “Proposed Sharing Agreement” field 312. In some embodiments, the “Proposed Sharing Agreement” field 312 may be embodied as a bitmap where Is indicate that certain sharing agreements are proposed by the sending AP to the receiving AP, and Os indicating the subset of agreements not proposed. The bitmap may comprise a single 1 or alternatively the mandatory field may contain an integer that indicates a number that identifies a particular agreement.

The AP-MLD which receives a “BW sharing agreement request” frame learns the capabilities of the sending AP-MLD (if this is the first received “BW sharing agreement request” frame) and learns about the proposed sharing agreement(s).

In some embodiments, the receiving AP-MLD may respond with a “BW sharing response frame” which may possibly contain two fields, one optional and one mandatory. The optional field 310 may indicate the set of supported agreements (for example sent only once or when completely new agreements are to be setup), and a second mandatory field 312 that indicates which agreement is selected among the proposed agreements, or which other agreement(s) may be proposed back to the transmitting AP-MLD.

In some embodiments, the two AP-MLD may require more than one iteration to reach an agreement. In other embodiments, the AP-MLDs may not reach an agreement and will continue to operate independently.

In other embodiments, if the AP-MLDs reach an agreement, they may both send a “BW sharing indication element” to their connected devices to indicate any change in the communication parameters. The communications parameters may be transmitted towards all associated STAs using beacons as they share the primary channel with the associated AP-MLD.

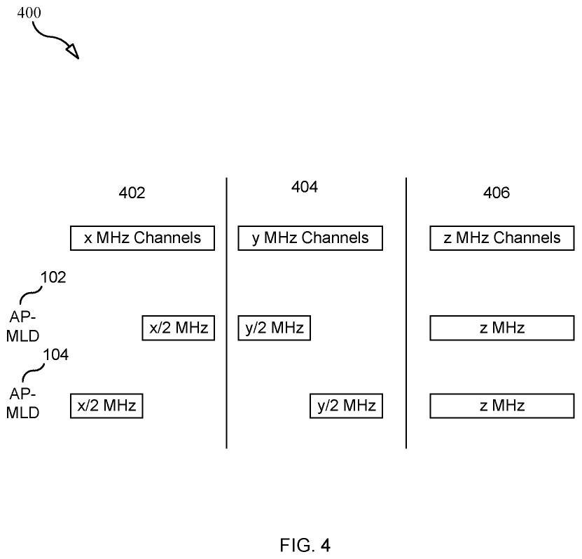

The first 102 and second 104 AP-MLD may reach an agreement 400. FIG. 4 shows an agreement 400 between two AP-MLDs. Agreement 400 may be embodied as a global agreement spanning three bands 402, 404, and 406. (e.g., 2.4 GHz, 5 GHz, and 6 GHz). As illustrated in FIG. 4, the first 102 and second 104 AP-MLDs may agree on the first AP-MLD 102 operating on the upper half of any x MHz portion in band 402 and on the lower half of any y MHz portion in band 404, while the second AP-MLD 104 can operate on the opposing portions. The AP-MLDs may also agree on sharing the whole z MHz portions in band 406. If these frequency portions are assumed as being the regulated channels, such agreement could be compactly specified using the channel numbers in IEEE 802.11.

In other embodiments, more than two AP-MLDs may come to an agreement where each AP-MLD uses a fraction of the available bandwidth. For example, in embodiments with three APs, AP1, AP2 and AP3 maybe get ⅙, ⅙ and ⅔ respectively of a certain x MHz portion in band 402, and all operate on whole z MHz portions in band 406 (band 404 being for example not used).

In some embodiments, the AP-MLDs may agree on potentially operating on
a) fully shared bandwidth part;
b) completely disjoint bandwidth part;
c) sharing a sub-part of the bandwidth; and/or
d) not operating on certain frequency bands and/or channels.

Potentially operating means that AP-MLDs may operate on all these channels if they need. In some embodiments, this agreement is global in that it is across all available license-exempt bands (e.g., 2.4, 5, 6 and 60 GHz).

Additionally, the AP-MLDs may also agree on how many and which channels each of them shall operate, in a shared or disjoint mode, while leaving the other channels for potential operation.

In addition, the agreement may contain under what priority an AP-MLD will operate. For example, one AP-MLD may use access category (AC) best effort, whereas another AP-MLD may use AC voice on a certain channel or set of channels. Furthermore, the agreement may contain under what TID (traffic identifier) an AP-MLD will operate.

Additionally, as part of the agreement or as a further modification to it, the AP-MLDs may also agree on using spatial reuse features to favor coexistence on the same frequency resources (shared or partially shared).

In one embodiment, the operation on the shared bandwidth part is further specified. For example, all AP-MLDs may use the shared bandwidth as a common primary channel, only for emergency messages, only for management purposes, only for STAs that do not support the other bands, or for background traffic only.

When AP-MLDs with different capabilities need to setup an agreement, an exchange of information, for example through beacons when a common primary channel is available, happens so that they are aware of each other's capabilities and operating channels/bandwidths. With such knowledge, appropriate agreements may be established between the AP-MLDs.

### 3. Agreement Re-Negotiation

In some embodiments, the AP-MLDs may need to renegotiate the current global agreement after a period of time. Such negotiation may be done locally or globally. The AP-MLDs may renegotiate the agreement globally, possibly with limited signaling, provided that one of the available global agreements would satisfy the new requirements of the AP-MLD asking for a renegotiation. Alternatively, the AP-MLDs may negotiate the agreement locally, namely only on the set of channels that are currently used by these AP-MLDs.

In one embodiment, a freshly negotiated (local) agreement may last for a pre-defined period of time and after which the AP-MLDs may fall back to the previous (global) agreement.

### 4. Triggering a Re-Negotiation

The AP-MLDs may have one or more conditions for triggering a re-negotiation. In some embodiments, the one or more conditions for triggering a (local) agreement re-negotiation at an AP-MLD may include:
traffic needs change at one AP-MLD, and it requests to be allocated a larger bandwidth part;
some bandwidth parts are interfered for an AP-MLD, have low signal to interference & noise ratio (SINR);
a guard band is setup on some channels, for example to limit out-of-band (OOB) emissions and possibly favor simultaneous transmit and receive operations;
coordination across AP-MLDs is introduced so that for example only DL transmissions happen at the same time on a certain band; and
an agreement with other coexisting AP-MLDs is being currently setup. In some embodiments, it may be useful to leave some channels/bands for other AP-MLDs with overlapping service areas.

These conditions for triggering an agreement renegotiation may be signaled between the AP-MLDs.

In some embodiments, when the re-negotiation fails the AP-MLDs may fall back to the original global agreement, or may fallback to operating independently. The re-negotiation may be carried out only for the required channels. Also, a re-negotiation may happen on a certain common channel, say channel 1, but may be relevant for other channels as well, for example channel 2 and channel 3.

### 5. Establishing the Re-negotiated Agreement

Once the re-negotiation has been triggered by an AP-MLD, the AP-MLD may transmit a message for proposing one or more changes in the agreement to a responding AP-MLD. The responding AP-MLDs may accept the proposed changes. In other embodiments, the responding AP-MLD may propose a different agreement. Alternatively, some changes may be mandatory to accept for example depending on the type of traffic, e.g., if critical traffic must be accommodated at the requesting AP-MLD, the responding AP-MLD in some instances has to accept the proposed agreement. Similarly, an AP-MLD may have to accept a request if it is only serving background traffic.

In another embodiment, a decision taken by a primary AP-MLD could be mandatory if there is hierarchy between the AP-MLDs. For example, one AP-MLD may serve as a primary AP-MLD, and in such case, the decision taken by the primary AP-MLD will be followed by all secondary AP-MLDs. In yet another embodiment, an AP-MLD with extended capabilities may impose decisions on an AP-MLD with limited capabilities.

The traffic requirements are known locally at each AP-MLD. Neighboring AP-MLDs do not know if the traffic needs announced by their neighbors are correct or not. As such, complying with a neighboring AP-MLD's request may be very advantageous for an AP-MLD. If a neighboring AP-MLD announces that a certain traffic need exists, it's in the interest of other AP-MLDs to consider these needs because it may be expected that a certain frequency channel will be heavily occupied.

In some embodiments, an AP-MLD may accept to release part of its bandwidth to another AP-MLD under the promise/trust that such bandwidth would be returned when needed.

### 6. Making an Agreement for a First Channel Using a Second Channel

In another embodiment, two AP-MLDs that are not in range in a first frequency band can re-negotiate their first frequency band spectrum usage agreement by exchanging messages in a second frequency band where the two AP-MLDs are in range. The communication on the second band may result in the setup/modification/turning on/turning off the spectrum usage agreement in the first band. The embodiments described herein for global spectrum usage agreement or local spectrum usage agreement as discussed previously apply here as well.

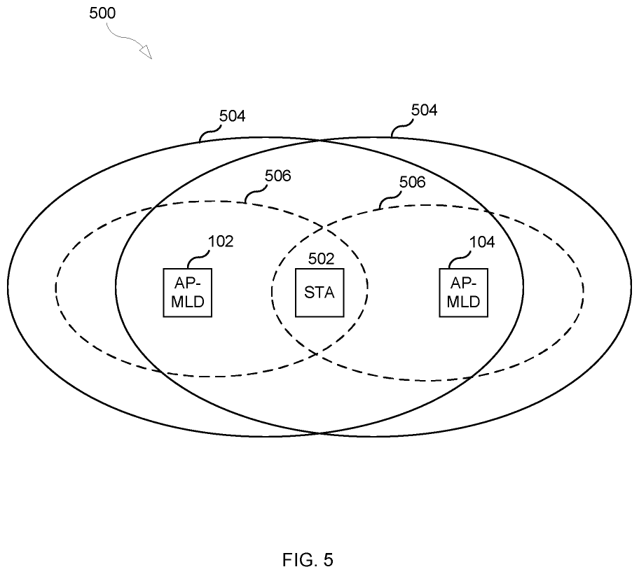

FIG. 5 shows an illustration of the first 102 and second 104 AP-MLD when they are in range using one frequency band (with coverage area 504) and not in range using another frequency band (with coverage area 506). In wireless network system 500, each of the first 102 and second 104 AP-MLD's operate on two frequency bands, each with a different coverage area. The first AP-MLD 102 communicates on a first frequency band 504 (e.g., 6 GHz band) with its connected STA 502 and with the second AP-MLD 104. The second AP-MLD 104 can communicate on the first frequency band 504 with first AP-MLD 102.

In some embodiments, when the first AP-MLD 102 transmits towards the STA 502 for example using the first 504 and the second 506 frequency bands, the STA 502 may experience interference from the second AP-MLD 104. The interference can occur on the first 504 and second 506 frequency bands. However, first 102 and second 104 AP-MLD may have a common channel only in the first frequency band 504, by using which they may coordinate their operations in the second frequency band 506. In the present embodiment, the first 102 and second 104 AP-MLD's can re-negotiate the second frequency band 506 spectrum usage agreement by using the communication channel in the first frequency band 504.

As part of the re-negotiation, or initial agreement setup, the first AP-MLD 102 may transmit a message that includes information about one or more actions associated with a second channel in the second frequency band. The message may include historic, current, and future information about one or more actions associated with a second channel in the second frequency band.

The first AP-MLD 102 may receive a message from the second AP-MLD 104. Based on the received message, the first AP-MLD 102 may tune transmit parameters in the first 504 and/or second 506 frequency bands; orthogonalize communications in the first 504 and/or second 506 frequency bands in time and/or frequency; adjust preamble detection thresholds corresponding to the first 504 and/or second 506 frequency bands; adjust channel access parameters corresponding to the first 504 and/or second 506 frequency bands;

intermittently pause transmissions on the first 504 and/or second 506 frequency bands; terminate operations on one or more and moving the terminated operations to a different operating channel; select a transmission direction for the first 504 and/or second 506 frequency bands; and/or adapt beamformed transmissions so as to keep emissions from interfering with beamformed transmissions of the second AP-MLD 104.

In other embodiments, a similar problem can occur when there is another STA, say STA2 (not shown in FIG. 5) connected with AP-MLD 104 and operating in UL. If STA2 is located close to the STA 502 in FIG. 5, it can happen that the STA's 502 receptions are disturbed. If the STA 502 experiences harmful interference in the second frequency band 506 it can report this to AP-MLD 102, and in turn AP-MLD 102 can renegotiate the second frequency band 506 spectrum usage agreement on the first frequency band 504 channel with the AP-MLDs so that the AP-MLDs can (better) coordinate their operations in the second frequency band 506.

### 7. Extending an Agreement to a New AP-MLD

In some embodiments, once an agreement has been setup between two or more AP-MLDs, all in range of each other, a further AP-MLD turns on. Such further AP-MLD's may be in range a) with all other AP-MLDs or b) with some of the AP-MLDs in agreement. The AP-MLDs can learn about each other's in range AP-MLD sets by exchanging the Neighboring Report through beacon transmissions.

In other embodiments, when a new AP-MLD is detected, a new agreement may be established between all AP-MLDs. In such embodiments, all of the AP-MLDs may be in range with each other for at least one channel.

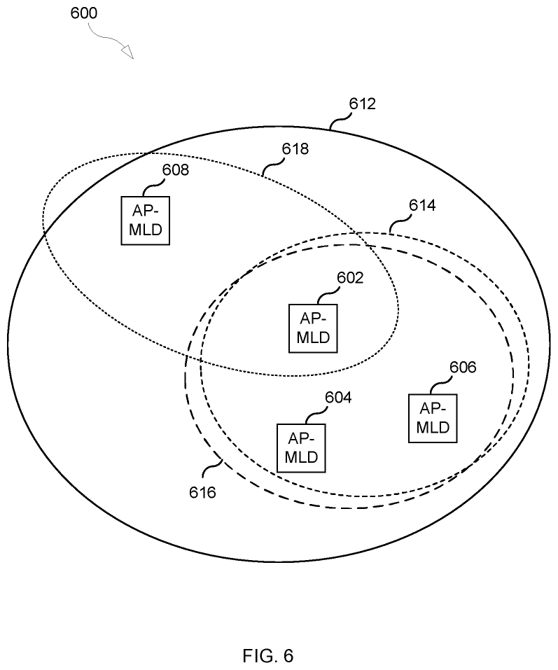

FIG. 6 shows a wireless network system when a new AP-MLD is not in range of all existing AP-MLDs according to some embodiments. Wireless network system 600 includes a first 602, a second 604, a third 606, and a fourth 608 AP-MLD. In FIG. 6, the first AP-MLD is in range 612 of the second 604, third 606, and fourth 608 AP-MLD. The second AP-MLD is in range 614 of first 602 and third 606 AP-MLD. The third AP-MLD 606 is in range 616 of the first 602 and second 604 AP-MLD. The fourth AP-MLD 608 is in range 618 of only the first 602 AP-MLD. At the beginning of the operation, suppose an agreement is setup between in range AP-MLDs (the first 602, second 604, and third 606 AP-MLDs). Then the fourth AP-MLD 608 begins activities and is in range of the first AP-MLD 602. In this embodiment, the first AP-MLD 602 can setup a second agreement with the fourth AP-MLD 608, so that the fourth AP-MLD 608 can reuse the same frequency resources as the second 604 and third 606 AP-MLDs (as these APs are not in range spatial reuse can occur).

It should be however noted that in FIG. 6 only the service areas of the four AP-MLDs are shown. In some embodiments, UL transmissions in BSS4 interfere with the operations in BSS2 and BSS3. If this occurs frequently then it may be not viable to use the agreement as described above and a new agreement involving all the four AP-MLDs may be needed again.

### 8. Making an Agreement in a Dense AP-MLD Deployment

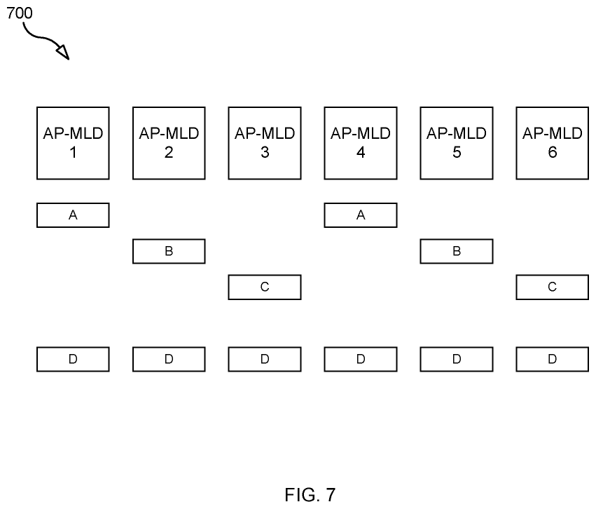

FIG. 7 illustrates a dense AP-MLD deployment scenario. In network 700, each AP-MLD, except AP-MLD1 and AP-MLD6, have two neighboring AP-MLDs. By exchanging the Neighboring Reports in the common communication channel, the AP-MLDs may learn that most of them have two neighboring AP-MLDs. For example, an agreement may exist to divide the frequency spectrum in four parts: A, B, C and D. In FIG. 7, D is left for shared use and any AP-MLD can use this frequency band as needed. As part of the agreement, each AP-MLD is assigned for exclusive use parts of the band as shown in FIG. 7: AP-MLD1 and AP-MLD4 use A, AP-MLD2 and AP-MLD5 use B, and so on. In this embodiment, if AP-MLD4 would like to re-negotiate its agreement with AP-MLD3 so that, for example, fractions of C are instead used by AP-MLD4 and not by AP-MLD3, this re-negotiation would not be a problem as even if AP-MLD6 reuses C, AP-MLD6 is however not in range of AP-MLD4. If such parts of the frequency band are chosen as described in the example here, then re-negotiating with a neighbor does not affect neighbor's neighbor operations.

In embodiments where the various AP-MLDs have the same (or similar) number of neighbors, the solution shown in FIG. 7 scales with the number of neighbors at each AP-MLD. If for example each AP-MLD has 4 neighbors AP-MLD, then the spectrum should be divided in 4+1+1 parts, namely A, B, C, D, E, and F and a similar allocation as in FIG. 7 should be selected.

Similarly, in some embodiments, it may happen that UL transmission in an out-of-range AP-MLD's BSS interfere at a given AP-MLD. For example, although AP-MLD2 is out of range of AP-MLD4, it may happen that UL transmission in BSS2 interfere with operations in BSS4 in FIG. 7. For this purpose, a relay option may be used by AP-MLD2 to talk with AP-MLD4.

### 9. Making an Agreement with an Out-of-Range AP-MLD

In some embodiments, two AP-MLDs may be unable to directly communicate as they are out-of-range, yet their transmissions may interfere with operations in their BSSs. For example, this situation is likely to happen with concurrent UL transmissions within each BSS or with concurrent DL transmissions (an STA may be much closer to a neighboring AP-MLD than its serving AP-MLD). If such interference occurs frequently, an AP-MLD may need to modify or setup an agreement with an out-of-range AP-MLD. In one embodiment, an AP-MLD may renegotiate an agreement with an out-of-range AP-MLD via a relaying AP-MLD that is in range of the two AP-MLDs. For example, in FIG. 7 AP-MLD3 may relay messages from AP-MLD2 to AP-MLD4.

In other embodiments, an AP-MLD may be aware of these out-of-range AP-MLDs by requesting Neighborhood Reports from its associated STAs. Furthermore, it may either broadcast the request to be relayed to this out-of-range AP-MLD or specifically ask an in-range AP-MLD if it can forward this request.

For example, suppose AP-MLD2 and AP-MLD4 use the same frequency resources in a certain channel in a certain band and that their operation in this band happens to interfere with each other, then AP-MLD2 may, for example ask, AP-MLD4 to:
use disjoint frequency resources within that channel in that band;
time-divide the use of the frequency resource in that channel in that band;
agree on that AP-MLD4 uses a different channel or a different band;
reduce transmit power so that spatial both AP-MLDs can spatially reuse the same frequency resources; and/or
ask that a certain type of communication should only be undertaken on this bandwidth part, e.g., only downlink transmissions, to remove unpredictable uplink interference.

In some embodiments, when out-of-range AP-MLDs modify their operating bandwidth, the modifications should be done so that the changes do not affect neighboring AP-MLD's operation.

### 10. Sharing a r-TWT SP Schedule and Orchestrating MAP Coordination

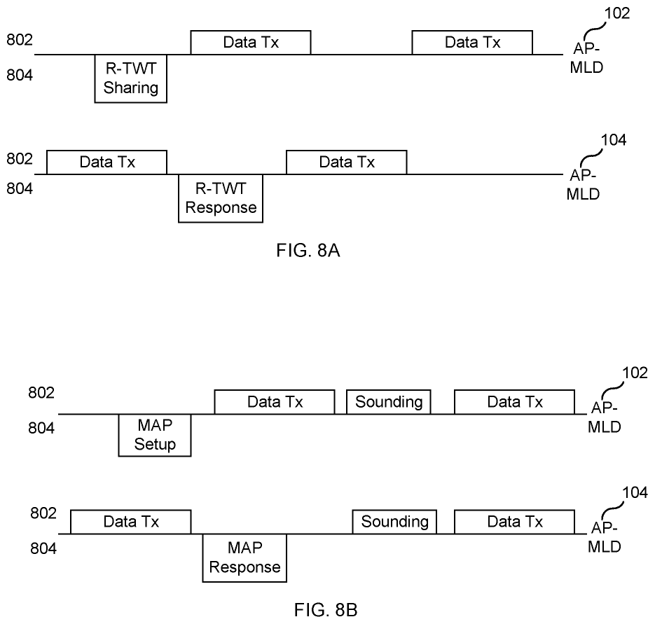

FIG. 8A illustrates sharing a r-TWT SP schedule corresponding to a first channel to another nearby AP MLD using a second channel. In FIG. 8A, the first AP-MLD 102 may share its r-TWT SP schedule corresponding to a first channel 802 to the second AP-MLD 104 using a second channel 804. As such, the second AP MLD 104 may take that information into consideration for operating on the first channel 802.

In FIG. 8A, the first AP-MLD 102 may detect that the second AP-MLD 104 has started transmitting and will keep transmitting over the r-TWT SP it has scheduled in the first channel. This prompts the first AP-MLD 102 to share its r-TWT information parameters with the second AP-MLD 104 using the second channel 804 with an intention of requesting the second AP-MLD 104 to facilitate its r-TWT operations on the first channel 802. When the second AP-MLD 104 receives the r-TWT parameters, it responds and acknowledges that it will restrict/adapt its operation on the first channel 802 in order to avoid or reduce interference during subsequent r-TWT SPs of the first AP MLD 102 on the first channel 802. In some embodiments, this response sent by the second AP MLD 104 may be optional, and may depend upon whether the second AP MLD 104 is willing to explicitly coordinate with first AP MLD 102 or independently aiming to perform its own helpful actions. Subsequently, when the next r-TWT SP of the first AP MLD 102 on first channel 802 comes around, the second AP MLD 104 stops its operation before the r-TWT SP time-window.

FIG. 8B illustrates initiating and orchestrating MAP coordination using one channel for a second channel. In FIG. 8B, the first AP-MLD 102 and second AP-MLD 104 exchange messages on the second channel 804 to agree on what type of coordination should be performed, followed by the actual coordinated transmissions on the first channel 802. This embodiment may be beneficial if, for example, one of the two channels is used more often than the other for communicating data. Therefore, in order to be as efficient as possible, the MAP coordination setup messaging occurs the second channel 804 whilst the actual MAP coordinated transmissions occur on the first channel 802. In this embodiment, the AP-MLDs decide to operate using CBF in order to null towards each other's associated non-AP STAs thereby involving a sounding phase before the actual data transmission phase.

In some embodiments, the first AP-MLD 102 and the second AP-MLD 104 may be in range of each other in both the first channel 802 and the second channel 804. In other embodiments, the first AP-MLD 102 and the second AP-MLD 104 may be in range using either the first channel 802 or the second channel 804 and not in range using the other respective channel.

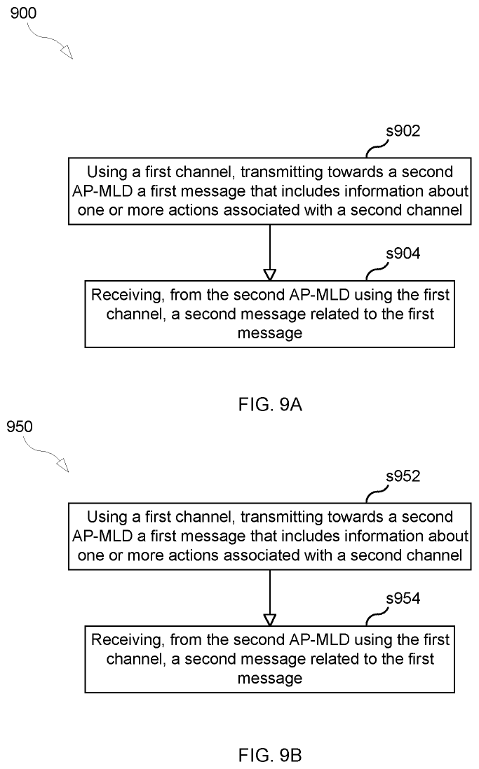

FIG. 9A a process 900 for performed by a first access point, AP, -multi-link device, MLD, AP-MLD, in a wireless network. The process 900 may begin with step s902. Step s902 comprises using a first channel, transmitting towards a second AP-MLD a first message that includes information about one or more actions associated with a second channel. Step s904 comprises receiving, from the second AP-MLD using the first channel, a second message related to the first message, wherein the first and second channels are different, the first AP-MLD and the second AP-MLD are in range using the first channel, and the first AP-MLD and the second AP-MLD are not in range using the second channel.

In some embodiments, the first channel and the second channel are located in the same frequency band.

In some embodiments, the first channel is located in a first frequency band and the second channel is located in a second frequency band, and the first frequency band and the second frequency band are different.

In some embodiments, the one or more actions associated with the second channel comprise: one or more historical actions of the first AP-MLD and/or the second AP-MLD associated with the second channel; one or more current actions of the first AP-MLD and/or the second AP-MLD associated with the second channel; and/or one or more future actions of the first AP-MLD and/or the second AP-MLD associated with the second channel.

In some embodiments, the information included in the first message includes information about one or more actions associated with each channel included in each of a plurality of frequency bands that the first AP-MLD can use for wirelessly communicating with other wireless devices.

In some embodiments, the information included in the first message identifies a first set of one or more proposals, and the first set of one or more proposals includes one or more of: (i) a proposal for allowing the first AP-MLD to use a particular channel as the second channel and/or to use a particular sub-channel in the second channel, (ii) a proposal for preventing the first AP-MLD from using a particular channel as the second channel and/or to use a particular sub-channel in the second channel, (iii) a proposal for allowing the second AP-MLD to use a particular channel as the second channel and/or to use a particular sub-channel in the second channel, and/or (iv) a proposal for preventing the second AP-MLD from using a particular channel as the second channel and/or to use a particular sub-channel in the second channel.

In some embodiments, the information included in the second message indicates an acceptance of at least one proposal included in the first set of one or more proposals and/or a rejection of at least one proposal included in the first set of one or more proposals.

In some embodiments, the information included in the second message identifies a second set of one or more proposals, the second set of one or more proposals includes (i) a proposal for allowing the first AP-MLD to use a particular channel as the second channel and/or to use a particular sub-channel in the second channel, (ii) a proposal for preventing the first AP-MLD from using a particular channel as the second channel and/or to use a particular sub-channel in the second channel, (iii) a proposal for allowing the second AP-MLD to use a particular channel as the second channel and/or to use a particular sub-channel in the second channel, and (iv) a proposal for preventing the second AP-MLD from using a particular channel as the second channel and/or to use a particular sub-channel in the second channel, and the first set of one or more proposals and the second set of one or more proposals are different.

In some embodiments, the first AP-MLD and the second AP-MLD are not in range using any channel where they both operate in the second frequency band.

In some embodiments, the first AP-MLD and the second AP-MLD are not in range using any channel in the second frequency band.

In some embodiments, process 900 further comprises receiving a third message that includes information about one or more actions associated with one or more channels, wherein the received third message was transmitted by a third AP-MLD capable of wirelessly communicating with the first AP-MLD using a channel in a frequency band where the first AP-MLD operates.

In some embodiments, process 900 further comprises using the first channel, forwarding towards the second AP-MLD the received third message.

In some embodiments, the first AP-MLD and the third AP-MLD are in range using at least one channel in at least one frequency band, and the second AP-MLD and the third AP-MLD are not in range using any channel where they both operate in any frequency band.

In some embodiments, the second AP-MLD and the third AP-MLD are not in range using any channel in any frequency band.

In some embodiments, process 900 further comprises in response to receiving the third message, transmitting towards the third AP-MLD a fourth message that includes information about one or more actions associated with one or more channels in one or more frequency bands.

In some embodiments, process 900 further comprises determining that a renegotiation condition is satisfied; and as a result of determining that the renegotiation condition is satisfied, using the first channel, transmitting towards the second AP-MLD a renegotiation message that includes information about one or more actions associated with the second channel, wherein the information included in the renegotiation message includes information about updated one or more actions associated with the second channel, and the updated one or more actions are associated with the renegotiation condition.

In some embodiments, the renegotiation condition comprises: detecting a change in the first AP-MLD's potential one or more actions associated with one or more channels one or more frequency bands; detecting interference in one or more frequency bands; establishing a guard band on one or more frequency bands; receiving a fifth message that includes information about one or more actions associated with one or more channels in one or more frequency bands, wherein said fifth message was transmitted by a fourth AP-MLD; and/or detecting a fifth AP-MLD.

In some embodiments, process 900 further comprises, based on the received second message: tuning transmit parameters in one or more frequency bands; orthogonalizing communications in one or more frequency bands in time and/or frequency; adjusting preamble detection thresholds corresponding to one or more frequency bands; adjusting channel access parameters corresponding to one or more frequency bands; intermittently pausing transmissions on one or more frequency bands; terminating operations on one or more and moving the terminated operations to a different operating channel; selecting a transmission direction for one or more frequency bands; and/or adapting beamformed transmissions so as to keep emissions from interfering with beamformed transmissions of the second AP-MLD.

In some embodiments, process 900 further comprises, based on the received second message, the first AP MLD selecting a common primary channel with the second AP MLD for future transmissions towards the second AP-MLD done via beacons.

In some embodiments, process 900 further comprises, based on the received second message, the first AP MLD selecting a common channel with the second AP MLD for future transmissions towards the second AP MLD.

In some embodiments, process 900 further comprises, based on the received second message, scanning a frequency band; and selecting a channel in the frequency band for future transmissions towards the second AP MLD using the results of the scan.

In some embodiments, process 900 further comprises, based on the received second message, selecting a common channel with the second AP MLD for future transmissions towards the second AP MLD, wherein the received second message identifies the common channel.

In some embodiments, process 900 further comprises based on the received second message, selecting a common channel with the second AP MLD for future transmissions towards the second AP MLD, wherein selecting the common channel is based on: higher priority (e.g., video or voice) data is communicated less frequently over the common channel when compared to other channel(s), lesser amount of higher priority (e.g., video or voice) data is communicated over the common channel when compared to other channel(s), the common channel is less busy (e.g., due to lesser amount of data traffic communicated over it) when compared to other channel(s), the common channel is less noisy (e.g., due to fewer interfering transmissions) than other channel(s), the common channel occupies less bandwidth (e.g., control signaling is transmitted in a non-HT DUP format which means that it is more spectrally efficient to use narrower channels for this communication) than other channel(s).

In some embodiments, the received second message includes mandatory uses of the second channel, wherein the mandatory uses indicates the first AP-MLD at least one of (i) must not use the second channel, (ii) must use the second channel, and/or (iii) must share the second channel.

In some embodiments, process 900 further comprises, based on the received second message, transmitting transmit parameters towards a first non-AP device.

In some embodiments, transmitting the transmit parameters toward the first non-AP device includes transmitting instructions for the first non-AP device to transmit the transmit parameters towards a non-AP second device.

In some embodiments, the first message is a multiple access point (MAP) coordination message or a restricted target wake time (r-TWT) message.

In some embodiments, the first channel and the second channel belong to a license-exempt frequency band.

In some embodiments, the first channel or the second channel belongs to a licensed frequency band.

FIG. 9B shows a process 950 performed by a first access point, AP,-multi-link device, MLD, AP-MLD, in a wireless network. Process 950 may begin with step s952. Step s952 comprises using a first channel, transmitting towards a second AP-MLD a first message that includes information about one or more actions associated with a second channel. Step s954 comprises receiving, from the second AP-MLD using the first channel, a second message related to the first message, wherein the first and second channels are different, and the first message is a multiple access point (MAP) coordination message or a restricted target wake time (r-TWT) message.

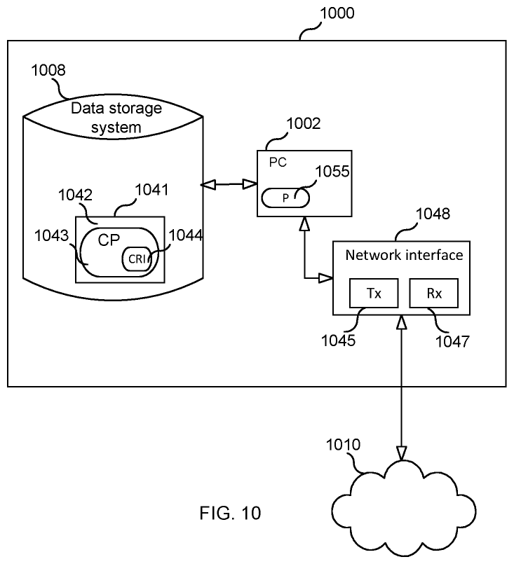

FIG. 10 is a block diagram of an apparatus (e.g., the first 102 and/or second 104 AP-MLB 104) according to some embodiments. Apparatus 1000 may perform any of the methods or processes described above. As shown in FIG. 10, the apparatus 1000 may comprise: processing circuitry (PC) 1002, which may include one or more processors (P) 1055 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., the network node may be a distributed computing apparatus); at least one network interface 1048 comprising a transmitter (Tx) 1045 and a receiver (Rx) 1047 for enabling the network node to transmit data to and receive data from other nodes connected to a network 1010 (e.g., an Internet Protocol (IP) network) to which network interface 1048 is connected (directly or indirectly) (e.g., network interface 1048 may be wirelessly connected to the network 1010, in which case network interface 1048 is connected to an antenna arrangement); and a storage unit (a.k.a., “data storage system”) 1008, which may include one or more non-volatile storage devices and/or one or more volatile storage devices. In embodiments where PC 1002 includes a programmable processor, a computer program product (CPP) 1041 may be provided. CPP 1041 includes a computer readable medium (CRM) 1042 storing a computer program (CP) 1043 comprising computer readable instructions (CRI) 1044. CRM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes the network node to perform steps described herein (e.g., steps described herein with reference to one or more of the flow charts). In other embodiments, the base station 104 may be configured to perform steps described herein without the need for code. That is, for example, PC 1002 may consist merely of one or more ASICs. Hence, the features of the embodiments described herein may be implemented in hardware and/or software.

While various embodiments of the present disclosure are described herein, it should be understood that they have been presented by way of example only, and not limitation. Thus, the breadth and scope of the present disclosure should not be limited by any of the above-described exemplary embodiments. Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel. That is, the steps of any methods disclosed herein do not have to be performed in the exact order disclosed, unless a step is explicitly described as following or preceding another step and/or where it is implicit that a step must follow or precede another step.

While various embodiments of the present disclosure are described herein, it should be understood the phrase “using” may be defined as both using alone or in combination with additional components. For example, the phrase “using A” may be only using A, but can also mean using A with B, C, and/or D. Additionally, it should be understood the term “range” may be defined as the maximum distance where communication can exist between two devices in a network base on physical characteristics on the propagating wave and its surroundings. Also, in the present disclosure, the terms ‘channels’ and ‘links’ are used interchangeably.

1. A method performed by a first access point, multi-link device (AP-MLD) in a wireless network, the method comprising:
using a first channel, transmitting towards a second AP-MLD a first message that includes information about one or more actions associated with a second channel; and
receiving, from the second AP-MLD using the first channel, a second message related to the first message, wherein
the first and second channels are different,
the first AP-MLD and the second AP-MLD are in range using the first channel, and
the first AP-MLD and the second AP-MLD are not in range using the second channel.

2. The method of claim 1, wherein
the first channel and the second channel are located in the same frequency band.

3. The method of claim 1, wherein
the first channel is located in a first frequency band and the second channel is located in a second frequency band, and
the first frequency band and the second frequency band are different.

4. The method of claim 1, wherein the
one or more actions associated with the second channel comprise:
one or more historical actions of the first AP-MLD and/or the second AP-MLD associated with the second channel;
one or more current actions of the first AP-MLD and/or the second AP-MLD associated with the second channel; and/or
one or more future actions of the first AP-MLD and/or the second AP-MLD associated with the second channel.

5. The method of claim 1, wherein the information included in the first message includes information about one or more actions associated with each channel included in each of a plurality of frequency bands that the first AP-MLD can use for wirelessly communicating with other wireless devices.

6-10. (canceled)

11. The method of claim 1, comprising:
receiving a third message that includes information about one or more actions associated with one or more channels, wherein
the received third message was transmitted by a third AP-MLD capable of wirelessly communicating with the first AP-MLD using a channel in a frequency band where the first AP-MLD operates.

12-15. (canceled)

16. The method of claim 1, comprising:
determining that a renegotiation condition is satisfied; and
as a result of determining that the renegotiation condition is satisfied, using the first channel, transmitting towards the second AP-MLD a renegotiation message that includes information about one or more actions associated with the second channel, wherein
the information included in the renegotiation message includes information about updated one or more actions associated with the second channel, and
the updated one or more actions are associated with the renegotiation condition.

17. (canceled)

18. The method of claim 1, comprising:
based on the received second message:
tuning transmit parameters in one or more frequency bands;
orthogonalizing communications in one or more frequency bands in time and/or frequency;
adjusting preamble detection thresholds corresponding to one or more frequency bands;
adjusting channel access parameters corresponding to one or more frequency bands;
intermittently pausing transmissions on one or more frequency bands;
terminating operations on one or more and moving the terminated operations to a different operating channel;
selecting a transmission direction for one or more frequency bands; and/or
adapting beamformed transmissions so as to keep emissions from interfering with beamformed transmissions of the second AP-MLD.

19. The method of claim 1, comprising:
based on the received second message, the first AP MLD selecting a common primary channel with the second AP MLD for future transmissions towards the second AP-MLD done via beacons.

20. The method of claim 1, comprising:
based on the received second message, the first AP MLD selecting a common channel with the second AP MLD for future transmissions towards the second AP MLD.

21. The method of claim 1, comprising:
based on the received second message, scanning a frequency band; and
selecting a channel in the frequency band for future transmissions towards the second AP MLD using the results of the scan.

22. The method of claim 1, comprising:
based on the received second message, selecting a common channel with the second AP MLD for future transmissions towards the second AP MLD, wherein the received second message identifies the common channel.

23. The method of claim 1, comprising:
based on the received second message, selecting a common channel with the second AP MLD for future transmissions towards the second AP MLD, wherein selecting the common channel is based on:
higher priority (e.g., video or voice) data is communicated less frequently over the common channel when compared to other channel(s),
lesser amount of higher priority (e.g., video or voice) data is communicated over the common channel when compared to other channel(s),
the common channel is less busy (e.g., due to lesser amount of data traffic communicated over it) when compared to other channel(s),
the common channel is less noisy (e.g., due to fewer interfering transmissions) than other channel(s),
the common channel occupies less bandwidth (e.g., control signaling is transmitted in a non-HT DUP format which means that it is more spectrally efficient to use narrower channels for this communication) than other channel(s).

24. (canceled)

25. The method of claim 1, wherein the method further comprises:
based on the received second message, transmitting transmit parameters towards a first non-AP device.

26. (canceled)

27. The method of claim 1, wherein
the first message is a multiple access point coordination message or a restricted target wake time message.

28. The method of claim 1, wherein
the first channel and the second channel belong to a license-exempt frequency band.

29. The method of claim 1, wherein
the first channel or the second channel belongs to a licensed frequency band.

30. A method performed by a first access point, multi-link device (AP-MLD) in a wireless network, the method comprising:
using a first channel, transmitting towards a second AP-MLD a first message that includes information about one or more actions associated with a second channel; and
receiving, from the second AP-MLD using the first channel, a second message related to the first message, wherein
the first and second channels are different, and
the first message is a multiple access point (MAP) coordination message or a restricted target wake time (r-TWT) message.

31. A first access point, multi-link device (AP-MLD), the first AP-MLD comprising:
a memory; and
a processing circuitry coupled to the memory, wherein processing circuity is configured to cause the first AP-MLD to:
using a first channel, transmit towards a second AP-MLD a first message that includes information about one or more actions associated with a second channel; and
receive, from the second AP-MLD using the first channel, a second message related to the first message, wherein
the first and second channels are different,
the first AP-MLD and the second AP-MLD are in range using the first channel, and
the first AP-MLD and the second AP-MLD are not in range using the second channel.

32-59. (canceled)

60. A first access point, multi-link device (AP-MLD), the first AP-MLD comprising:
a memory; and
a processing circuitry coupled to the memory, wherein processing circuity is configured to cause the first AP-MLD to:
using a first channel, transmit towards a second AP-MLD a first message that includes information about one or more actions associated with a second channel; and
receive from the second AP-MLD using the first channel, a second message related to the first message, wherein
the first and second channels are different, and
the first message is a multiple access point (MAP) coordination message or a restricted target wake time (r-TWT) message.

61-62. (canceled)
